(19) United States
(12) Patent Application Publication
(10) Pub. No.: US 2011/0223534 A1
(43) Pub. Date: Sep. 15, 2011

(54) HYDROPHOBILIZATION METHOD FOR PARTICLES

(75) Inventors: Koji SHIBATA, Tokyo (JP); Mikio KOUYAMA, Tokyo (JP); Kenji HAYASHI, Tokyo (JP); Yukio HOSOYA, Tokyo (JP); Hiroaki OBATA, Tokyo (JP)

(73) Assignee: KONICA MINOLTA BUSINESS TECHNOLOGIES, INC., Tokyo (JP)

(21) Appl. No.: 13/038,447

(22) Filed: Mar. 2, 2011

(30) Foreign Application Priority Data
Mar. 10, 2010 (JP) 2010-052759

(51) Int. Cl. G03G 9/08

(52) U.S. Cl. 430/137.1

(57) ABSTRACT

A hydrophobilization method is disclosed, comprising subjecting particles to a hydrophobilizing treatment in an aqueous medium with a hydrophobilizing agent to hydrophobilize surfaces of the particles, wherein the surfaces of the particles are hydrophobilized with the hydrophobilizing agent in the presence of a phase transfer catalyst.

This application claims priority from Japanese Patent Application No. 2010-052759, filed on Mar. 10, 2010, which is incorporated hereinto by reference.

### FIELD OF THE INVENTION

The present invention relates to a method of hydrophobilizing a particle surface, and in particular to a surface treatment method for hydrophobilizing inorganic particles, organic particles or organic-inorganic composite particles.

### BACKGROUND OF THE INVENTION

Recently, there have been noted technologies for particle design. For instance, particles having a hydrophilic group on their surfaces have been used in various environments but producing problems such that, when used in various environments, fluidity or electrostatic charge property of the particles varied depending on the humidity in the environment in which it is to be used, adversely affecting the performance or operability thereof.

For example, an additive, of a sub-micrometer order, called external additive was added to an electrophotographic developer, a so-called toner to control fluidity, electrostatic-charging performance or cleaning performance but there was a concern with respect to influence of a hydrophilic group existing on the surface of an external additive. There have been used external additives, such as inorganic particles of a metal oxide or the like, organic particles of a polymer compound or the like, or organic-inorganic composite particles. Examples of inorganic particles broadly used include metal oxides such as silicon dioxide, titanium dioxide and aluminum oxide.

Synthesis methods of silicon dioxide particles, as typical metal oxide particles, include two kinds of a wet process and a dry process. Of wet processes generally known is a sol-gel method. In the sol-gel method, a silane alkoxide is hydrolyzed in the presence of an alkali and is further subjected to polycondensation to obtain a silicon dioxide. Of dry processes generally known is a combustion method, in which a silane compound such as tetrachlorosilane is subjected to combustion under a hydrogen stream to obtain silicon dioxide particles. The thus obtained silicon dioxide particles have a siloxane structure or a silanol group on their surfaces and exhibit hydrophilicity.

However, these metal oxide particles, on the surfaces of which a hydrophilic group exists, are easily affected by humidity of the working environment when used as an external additive for a toner. Specifically, the electrostatic charge amount is reduced or fluidity is lowered, causing image troubles such as fogging. Accordingly, there have been used metal oxide particles which were surface-hydrophobilized. Specifically, a silanol group is substituted by a methyl group or the like by using a hydrophobilizing agent to perform hydrophobilization.

There have also been known hydrophobilizing agents for a metal oxide used as an external agent, including an organic silazane hydrophobilizing agent such as hexamethyldisilazane, an organic siloxane hydrophobilizing agent such as dimethyl polysiloxane and a silane compound such as dimethyldimethoxysilane.

Hydrophobilizing treatments generally include a gas phase process, a wet process and a direct reaction process, in which reaction is performed under high temperature or a solvent is necessitated. For instance, JP 7-061810A disclosed a technique in which hexamethyldisilazane used as a hydrophobilizing agent was mixed with silicon dioxide in a reaction vessel and heated at 150° C. to obtain hydrophobilized silicon dioxide. Further, JP 2008-174430A disclosed a technique in which, in a silicon dioxide dispersion prepared in an aqueous medium, the aqueous medium was replaced with methyl isobutyl ketone and hexamethyldisilazane was used as the hydrophobilizing agent, and the obtained mixture was reacted at 110° C. for 3 hours to perform hydrophobilization.

Thus, JP 2008-174430A disclosed the use of an organic solvent to dissolve a hydrophobilizing agent. On the contrary, the present invention is directed to a method of performing a hydrophobilization treatment in an aqueous medium without an organic solvent, while not dissolving a hydrophobilizing agent.

### SUMMARY OF THE INVENTION

Conventional techniques for a hydrophobilizing treatment require a high temperature reaction, in which energy consumption is large and also requires a gas phase reaction, in which treatments for exhaust gases produced from raw materials or byproducts are needed as environmental pollution control measure, necessitating a large amount of investment in facilities. Further, the necessity of an organic solvent and a high temperature reaction restrict usable raw materials. For example, there were problems that usable materials are limited such that the use of an organic solvent makes it impossible to use particles containing an organic compound soluble in such an organic solvent and a high temperature reaction renders it unfeasible to use a raw material which is degradable at high temperatures.

Accordingly, it is an object of the present invention to provide a novel technique for a hydrophobilizing treatment which dissolves the foregoing problems and is applicable to a hydrophobilizing treatment for particles constituted of organic or inorganic materials of a broad range, including inorganic particles, organic particles and organic-inorganic composite particles. It is also an object of the present invention to provide a technique for a hydrophobilizing treatment which is performed through a low temperature reaction without necessitating a reaction at a high temperature or a gas phase reaction and also without using an organic solvent.

The foregoing problems are dissolved by the following constitution. One aspect of the invention is directed to a hydrophobilization method comprising subjecting particles to a hydrophobilizing treatment in an aqueous medium with a hydrophobilizing agent to hydrophobilize surfaces of the particles,

wherein the surface of each of the particles is hydrophobilized with the hydrophobilizing agent in the presence of a phase transfer catalyst.

The foregoing constitution of the invention makes it unnecessary to perform a reaction at a relatively high temperature or to use an organic solvent, and rendering it feasible to perform a simple hydrophobilizing treatment and thereby enabling to perform a hydrophobilizing treatment of particles composed of various kinds of materials, such as inorganic particles, organic particles or organic-inorganic composite particles.

### DETAILED DESCRIPTION OF THE INVENTION

While the present invention will hereinafter be described with reference to preferred embodiments thereof, the embodiments of the invention are by no means limited to these.

As described above, in the hydrophobilizing treatment in an aqueous medium, the use of a phase transfer catalyst makes it possible to disperse even an aqueous-insoluble hydrophobilizing agent in water, and rendering it feasible to submit the surfaces of particles dispersed in an aqueous medium to hydrophobilization reaction. Further, the method of the invention makes it possible to obtain particles with a sufficient degree of hydrophobicity without employing a high temperature reaction or an organic catalyst, as known in the prior art.

A phase transfer catalyst is a reagent to allow an aqueous-insoluble compound to react with a compound insoluble in an organic solvent, and examples of such a commonly known phase transfer catalyst include a quaternary ammonium compound and phosphonium compound which are soluble in water and an organic solvent.

Namely, when a phase transfer catalyst is added to a mixture of a hydrophobilizing agent and particles such as inorganic particles, organic particles or organic-inorganic composite particles, the phase transfer catalyst which is soluble in both water phase and an oil phase, promotes reaction between the hydrophobilizing agent which is water-insoluble and separated from a water phase, and the foregoing particles existing in an aqueous medium.

Thus, when a phase transfer catalyst is used, a hydrophobilizing agent forming an oil phase is incorporated, in a state close to a molecular state, into water having particles dispersed, resulting in enhanced frequency of contact with the particles and leading to an enhanced hydrophobilization degree. The phase transfer catalyst is usually used for allowing a water-insoluble compound and an organic solvent-insoluble compound to react with each other, namely, for a chemical reaction thereof. On the other hand, in the present invention, a water-insoluble hydrophobilizing agent becomes incorporated into water by use of a phase transfer catalyst, leading to promotion of the reaction. Namely, the phase transfer catalyst used in the invention does not directly contribute to the reaction but acts as an accelerator for supplying reaction components.

### Hydrophobilization Treatment:

The hydrophobilizing treatment of the invention is performed by adding a phase transfer catalyst is added to an aqueous medium containing particles with attached hydrophilic groups and a hydrophobilizing agent. The aqueous medium represents a medium containing at least 95% by mass of water, which may contain a water-soluble solvent, such as an alcohol.

A hydrophobilizing treatment is conducted according the procedure, as described below:

(1) Preparation of a dispersion of particles with attached hydrophilic groups,

(2) addition of a hydrophobilizing agent and a phase transfer catalyst to the dispersion to form a mixture, and

(3) heating the mixture with stirring to promote a hydrophobilizing treatment reaction.

The foregoing particle dispersion preferably has a solid content of 1 to 40% by mass. An excessively high solid content results in excessively high viscosity and insufficient-stirring, leading to insufficient mixing with the phase transfer catalyst, and giving rise to concern that the hydrophobilizing reaction does not proceed efficiently. Further, an excessively low solid content may result in troubles in productivity.

The hydrophobilizing treatment is conducted at a liquid temperature of 30 to 80° C., and more preferably 30 to 50° C. The hydrophobilizing treatment is conducted preferably over a period of 2 to 5 hours with stirring to perform a hydrophobilizing reaction. The extent of a hydrophobilization is preferably at a methanol wettability of 40 to 90%.

### Measurement of Hydrophobicity:

A degree of hydrophobilization is represented in terms of methanol wettability. Methanol wettability (%) is to evaluate wettability to methanol, as defined below:

Degree of hydrophobicity (methanol wettability)=[a/(a50)]×100

Specifically, the degree of hydrophobicity is determined as follows. Particles of 0.2 g are weighed out and added into 50 ml of distilled water in a 200 ml beaker. Methanol is gradually dropwise added with stirring from a burette, the top of which is inserted into liquid, until all particles are wetted (or sedimented). The degree of hydrophobicity is calculated by the foregoing formula, provided that “a” is a volume (ml) of methanol necessary to wet all particles.

### Phase Transfer Catalyst:

A phase transfer catalyst usable in the invention preferably preferably is a quaternary ammonium compound or a phosphonium compound, represented by the following formula:

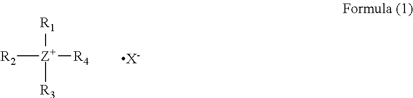

In the foregoing formula (I), R₁, R₂, R₃ and R₄, which may be the same or different, are each an aryl group, an alkyl group having 1 to 12 carbon atoms, or an aralkyl group; and preferably an alkyl group having 1 to 6 carbon atoms, each of which may be substituted. Examples of a substituents include an alkyl group, an alkoxy group, hydroxyl group, and a halogen atom. Z is a nitrogen atom or a phosphorus atom, and X is a fluorine atom, a chlorine atom, a bromine atom, an iodine atom or phosphorus hexafluoride (PF₆).

Of the phase transfer catalysts represented by the formula (I), a quaternary ammonium compound or a phosphonium compound is preferred. Specific examples of an alkyl ammonium compound, such as tetraalkyammonium compound include tetraethylammonium bromide, tetrabutylammonium bromide, tetrapropylammonium bromide, tetrapentylammonium bromide, tetrahexylammonium bromide, tetraethylammonium bromide, tetrabutylammonium chloride, tetrapropylammonium chloride, tetrapentylammonium chloride, tetrahexylammonium chloride, hexadecyltrimethylammonium hexafluorophosphate, (2-methoxyethoxymethyl)triethylammonium chloride, chloroethyltrimethylammonium chloride, (2-hydroxyethyl)trimethylammonium chloride, (2-chloroethyl)trimethylammonium chloride, and benzyltriethylmmonium chloride. Specific examples of a phosphonium compound include tetraethylphosphonium bromide, tetrabutylphosphonium bromide, tetrapropylphosphonium bromide, tetrapentylphosphonium bromide, tetrahexylphosphonium bromide, tetraethylphosphonium chloride, tetrabutylphosphonium chloride, tetrapropylphosphonium chloride, tetrapentylphosphonium chloride, tetrahexylphosphonium chloride, tetraphenylphosphonium bromde, benzyltriphenylphosphonium chloride, and tetrabutylphosphonium hexafluorophosphate. Phase transfer catalysts usable in the present invention are not limited to the foregoing compounds.

A phase transfer catalyst is contained preferably in an amount of not less than 0.1% by mass and not more than 20% by mass, based on a hydrophobilizing agent.

### Hydrophobilizing Agent:

Hydrophobilizing agents usable in the present invention include a silazane hydrophobilizing agent, a siloxane hydrophobilizing agent and a silane hydrophobilizing agent.

### Silazane Hydrophobilizing Agent:

Of silazane hydrophobilizing agent usable in the present invention is preferably used an organic silazane hydrophobilizing agent. Specific examples of such an organic silazane hydrophobilizing agent include hexamethyldisilazane, trimethyldisilazane, tetramethyldisilazane, hexamethylcyclotrisilazane, heptamethyldisilazane, diphenyltetramethyldisilazane, and divinyltetramethyldisilazane, but organic silazane hydrophobilizing agent usable in the invention are not limited to these.

### Siloxane Hydrophobilizing Agent:

Specific examples of a siloxane hydrophobilizing agent usable in the invention include methylhydrogen disiloxane, dimethyldisiloxane, hexamethyldisiloxane, 1,3-divinyltetramethyldisiloxane, 1,3-diphenyltetramethyldisiloxane, methylhydrogen polysiloxane, dimethyl polysiloxane, and amino-modified siloxane, but siloxane hydrophobilizing agents usable in the invention are not limited to the foregoing compounds.

### Silane Hydrophobilizing Agent:

Specific examples of a silane hydrophobilizing agent usable in the invention include 3-mercaptopropylmethyldimethoxysilane, and 3-methacryloxypropyldimethoxysilane.

### Particle to be Hydrophobilized:

In the present invention, particles which are to be subjected to a hydrophobilization treatment are preferably those which have a hydrophilic group on their surfaces. The hydrophilic group refers to a substituent exhibiting affinity for water. Examples of such a hydrophilic group include a hydroxyl group, a carboxyl group, a sulfonic acid group and a phosphoric acid group. Examples of the particles related to the invention include inorganic particles of silicon dioxide (hereinafter, also denoted as silica), titanium dioxide or the like, organic particles composed of an organic material such as poly(methyl methacrylate) and organic-inorganic composite particles constituted of an organic material and an inorganic material. These particles dispersed in an aqueous medium are used in hydrophobilization reaction. The average particle size thereof is not specifically limited but preferably is a volume-based median diameter of 10 nm to 10 μm. In cases when the particles related to the invention are used as an external additive for an electrophotographic toner, the volume-based median diameter of the particles preferably is 10 300 nm. In cases when the particles related to the invention are used for an electrophotographic toner, the volume-based median diameter of the particles is preferably from 3 to 8 μm. The hydrophobilizing method of the invention is an effective technique for inorganic particles or organic-inorganic composite particles in terms of no organic solvent being used.

Examples of inorganic particles usable in the invention include silicon dioxide, magnesium oxide, zinc oxide, lead oxide, alumina (aluminum oxide), tantalum oxide, indium oxide, bismuth oxide, yttrium oxide, cobalt oxide, copper oxide, manganese oxide, titanium oxide, selenium oxide, iron oxide, zirconium oxide germanium oxide, tin oxide, niobium oxide, molybdenum oxide, and vanadium oxide.

Examples of organic particles usable in the invention include poly(methyl methacrylate) resin particles, poly-styrene-co-(methyl methacrylate) resin particles, polyurethane resin particles, polyester resin particles, and particles of a mixed resin or copolymeric resin of at least of the foregoing resins. Such resin particles may be prepared in the form of a dispersion by a process of emulsion polymerization, suspension polymerization, solution suspension method, emulsion dispersion method or the like. Alternatively, there may be used a dispersion in which resin particles prepared by grinding resin blocks are dispersed in an aqueous medium by using a surfactant. The thus prepared resin particles may contain additives such as a colorant or a wax.

### Organic-Inorganic Composite Particle:

There may be employed organic-inorganic composite particles in which an inorganic layer is formed on organic particles, as described above.

### Preparation of Particle:

Methods for preparing particles related to the invention include techniques of (1) to (5), as described below.

(1) Silicon dioxide is deposited via a sol-gel method, as described below, onto the surfaces of latex particles prepared by emulsion polymerization or submicron particles such as microparticles prepared by a solution suspension method to form covered particles, whereby an organic-inorganic composite particle dispersion is prepared. Such latex particles can employ, for example, a styrene resin, an acryl resin, a methacrylic resin, or a co-polymeric resin thereof. There are also usable such resin particles having introduced an alkoxysilyl group on their surfaces.

(2) There is cited a dispersion of organic-inorganic composite particles, in which micron particles obtained by an emulsion polymerization coagulation method are covered with silicon dioxide particles by using a colloidal silica. Specifically, into a dispersion in which particles obtained by an emulsion polymerization aggregation method are added a cationic surfactant of a quaternary ammonium salt and an aqueous-soluble organic solvent, and further thereto is added a negatively charged silicon dioxide dispersion. A typical method for a negatively charged silicon dioxide dispersion is addition of an anionic surfactant such as a dodecylbenzene sulfonate to a silicon dioxide dispersion. Alternatively, there may be added a commercially available colloidal silica dispersion which has been adjusted to a pH of 4 (corresponding to an isoelectric point).

(3) There is also cited a dispersion of organic-inorganic composite particles, in which silicon dioxide is deposited, through a sol gel method described later, onto micron particles that are obtained by an emulsion polymerization coagulation method similarly to the foregoing technique (2). Specifically, a latex resin particle dispersion prepared by the foregoing emulsion polymerization or the like and a dispersion of a particulate colorant such as carbon black or the like are subjected to coagulation/coalescence to obtain a dispersion of coalesced particles of an average micron size. Further, silicon dioxide is deposited onto the obtained particle surface through a sol gel method, to be described later.

(4) Preparation of aqueous-dispersible colloidal silica:

An aqueous-dispersible colloidal silica may be prepared by a sol-gel method, as described later.

Alternatively, there may be employed commercially available aqueous-dispersible colloidal silica. Examples of such a commercially available aqueous-dispersible colloidal silica include colloidal silica SNOWTEX, produced by Nissan Kagaku Kogyo Co., Ltd., and including SNOWTEX XS, SNOWTEX OSX, SNOWTEX S, SNOWTEX 20, SNOWTEX 30, SNOWTEX 40, SNOWTEX O, SNOWTEX N, SNOWTEX C, SNOWTEX AK, SNOWTEX 50, SNOWTEX 0-40, SNOWTEX CM, SNOWTEX 20L, SNOWTEX OL, SNOWTEX XL, SNOWTEX ZL, MP-2040, MP-4540M, SNOWTEX UP, SNOWTEX OUP, SNOWTEX PS-S, SNOWTEX PS-M, and Lithium silicate 45.

(5) Methods of preparing organic particles include, for example, a method of preparing alkoxysilyl group-containing resin particles by using an alkoxysilyl group-containing monomer, as a monomer constituting the resin.

Herein, the alkoxysilyl group refers to a mono-valent silyl group, as represented by the following chemical formula:

—Si(OR₁)ₙ(R₂)₃₋ₙ

wherein R₁ and R₂ are each independently an alkyl group having 1 to 3 carbon atoms, and n is an integer of 1 to 3.

Specific examples of such a silyl group include a trimethoxysilyl group, tripropoxysilyl group, methyldimethoxysilyl group, methyldiethoxysilyl group, ethyldiethoxysilyl group, propyldiethoxysilyl group, dimethylmethoxyilyl group, dimethylethoxysilyl group, diethjylethoxysilyl group, and dipropylethoxysilyl group. Preferred examples of an alkoxysilyl group-containing, radical-polymerizable monomer include styryltrimethoxysilane, styryltriethoxysilane, 3-methacryloxypropylmethyldimethoxysilane, 3-methacryloxypropyltrimethoxysilane, 3-methacryloxypropylmethyldiethoxysilane, 3-methacryloxypropyltrimethoxysilane, 3-acryloxypropylmethyldiethoxysilane, 3-acryloxypropyltriethoxysilane, vinyltrimethoxysilane, and vinyltriethoxysilane.

Examples of a radical-polymerizable monomer not containing an alkoxysilyl group include styrene, (meth)acrylic acid, an alkyl (meth)acrylate, butadiene, butadiene, isoprene and propylene.

Alkoxysilyl group-containing resin particles can be prepared specifically by the processes described below:

(A) At least an alkoxysilyl group-containing, radical-polymerizable monomer is mechanically stirred in an aqueous medium to form droplets, followed by performing polymerization to form parent particles;

(B) At least an alkoxysilyl group-containing, radical-polymerizable monomer is dropwise added into an aqueous medium containing a surfactant to perform polymerization within micelles to form 100-150 nm polymeric particles, followed by addition of a coagulant to allow the polymer particles to be aggregated and fused to form particles.

Preparation methods of particles through a polymerization process, as described in the foregoing (2) and (3), include a suspension polymerization method, a polyester elongation method, a solution suspension method and an emulsion dispersion method other than the foregoing emulsion polymerization aggregation method. Of these methods, the emulsion polymerization coagulation method in which resin particles prepared by emulsion polymerization are coagulated and coalesced to form particles, is preferred in terms of preparation of particles of uniform shape or size.

### Sol-Gel Method:

Silica coverage by a sol-gel method is specifically performed as follows.

Latex particles forming parent particles are dispersed in water or an aqueous medium dissolving a silane alkoxide and this dispersion is dropwise added into alkali-containing water aqueous medium. Alternatively, latex particles are dispersed in the foregoing silane alkoxide solution and further thereto, an alkali-containing water or an aqueous medium is dropwise added. In this method, a silane alkoxide dissolved in a latex particle dispersion is hydrolyzed and polymerized in the presence of an alkali, and is gradually insolubilized to be deposited on the latex particle surface.

As a result, particulate blocks containing silicon dioxide are adhered to each other to form a covering layer. In this technique, to cause silicon dioxide particulate blocks to selectively cover the latex particle surface, latex particles may be dispersed in water or an aqueous medium dissolving a silane alkoxide and stirred, and optionally heated, whereby the silane alkoxide is swelled on the latex particle surface.

There are cited examples of a silane alkoxide usable in the invention. Examples of bi- or more functional silane alkoxide include tetramethoxysilane, methyltriethoxysilane, hexyltriethoxysilane, triethoxychlorosilane, di-t-butoxydiacetoxysilane, hydroxymethyltriethoxysilane, tetraethoxysilane, tetra-n-propoxysilane, tetrakis(2-methacryloxyethoxysilane), allyltriethoxysilane, allyltrimethoxysilane, 3-aminopropyltriethoxybis(triethoxysilyl)-1,7-octadiene, 2,2-(chloromethyl)allyltrimethoxysilane, [(chloromethyl)phenylethyl]trimethoxysilane, 1,3-divinyltetraethoxydisiloxane, epoxycyclohexyl)ethyltrimethoxysilane, (3-glycidoxypropyl)methyldiethoxysilane, (3-glycidoxypropyl)methyldimethoxysilane, (3-glycidoxypropyl)trimethoxysilane, 3-mercaptopropyltriethoxysilane, methacrylamidopropyltriethoxysilane, methacryloxymethyltriethoxysilane, methacryloxymethyltrimethoxysilane, 7-ocyenyltrimethoxysilane, vinylmethyldiethoxysilane, vinylmethyldimethoxysilane, vinyltriethoxysilane, and vinyltriphenoxysilane.

Examples of a mono-functional silane alkoxide capable of being used in combination the foregoing bi- or more functional silane alkoxide include (3-acryloxypropyl)dimethylmethoxysilane, o-acryloxy(polyethyleneoxy)trimethylsilane, acryloxytrimethylsilane, 1,3-bis(methacryloxy)-2-trimethylsiloxypropane, 3-chloro-2-trimethylsiloxypropene, (cyclohexenyloxy)trimethylsilane, methacryloxyethoxytrimethylsilane, and (methacryloxymethyl)dimethylethoxysilane. These silane alkoxides may be used singly or in combination of them.

The may be used, for example, alcohols such as methanol, ethanol, isopropyl alcohol as an aqueous medium usable in the foregoing sol-gel reaction. In cases when using such alcohols, an increased organic property of an organic solvent leads to increased solubility of a polycondensation product of a silane alkoxide, rendering it difficult to deposit the polycondensation product of a silane alkoxide on the particle surface, so that it is preferred to use methanol or ethanol as the foregoing aqueous medium. When particles to be subjected to a hydrophobilization treatment are those containing an organic material, it is necessary to add such alcohols in such an amount that the organic material is not dissolved.

### Preparation of Micron Size Particles:

There are usable a commonly known resin for preparation of micron-size particles through a grinding method, solution suspension method or the like. Examples of such a resin include a vinyl resin such as a styrene resin, (meth)acryl resin, styrene-(meth)acryl copolymer resin, or olefinic resin; a polyester resin, a polyamide resin, a polycarbonate resin, a polyether, a poly(vinyl acetate) resin, a polysulfone, an epoxy resin, a polyurethane resin, and a urea resin. These resins may be used singly or in combination thereof.

When preparing micron-size particles through a suspension polymerization method, a dispersion polymerization method, an emulsion polymerization aggregation method, a solution suspension method, an emulsion dispersion method or the like, examples of a polymerizable monomer to obtain a resin constituting the particles include vinyl monomers such as styrene, a styrene derivative, a methacrylic acid ester derivative, an acrylic acid ester derivative, or an acrylic acid or methacrylic acid derivative. These vinyl monomers may be used singly or in combination of them. It is also preferred to use a polymerizable monomer containing an ionic dissociative group, such as a carboxyl group, sulfonic acid group or phosphoric acid group in combination with the foregoing vinyl monomer. There may be used a polyfunctional vinyl monomer to obtain a binder resin of a cross-linking structure.

Of the above-described preparation methods, preparation of micron-size particles by an emulsion polymerization aggregation method is preferable in terms of dispersibility in an aqueous medium and controllability of particle size distribution.

Hereinafter, there will be described a process of aggregating resin particles in an emulsion polymerization aggregation method.

In the aggregation process, a coagulant is added at a concentration higher than the critical coagulation concentration to an aqueous dispersion of resin particles to cause salting-out and concurrently, coagulated particles are fused at a temperature higher than the glass transition temperature of a resin to promote growth of particles with aggregating particles. When reaching an intended particle size, a large amount of water is added thereto to terminate particle growth and the particle shape is controlled with smoothening the particle surface, while heating and stirring, whereby particle formation is performed.

In cases when used for an electrophotographic developer, resin particles are mixed with a dispersion of colored particles, wax particles, charge controller particles or other toner constituent particles as needed in the aggregation process to prepare a dispersion, which is coagulated with a coagulant and fused in an aqueous medium to form a toner particle dispersion.

Coagulants is not specifically limited but one chosen from metal salts are optimally used. Examples thereof include a salt of a monovalent metal such as an alkali metal of lithium, sodium or potassium; a salt of a divalent metal such as calcium, magnesium, manganese or copper and a salt of a trivalent metal such as iron or aluminum. Specific examples of such a salt include sodium chloride, potassium chloride, lithium chloride, calcium chloride, magnesium chloride, zinc chloride, copper sulfate, magnesium sulfate and manganese sulfate. Of these, a salt of a divalent metal is specifically preferred. The use of a divalent metal salt can achieve coagulation at a relatively small amount thereof. One or more metal salts may be used singly or in combination.

In the coagulation process, a solution is preferably allowed to stand for as short a time as possible after adding the coagulant (that is, a time of period up to starting heating). Namely, it is preferred that heating a dispersion used for coagulation is started as soon as possible after adding a coagulant, to a temperature higher than the glass transition temperature of the resin composition. The reason therefor is not definite but it is a concern that the coagulation state is varied with an elapse of standing time, resulting in an instable particle size distribution or variation in surface property. The standing time is preferably not more than 30 minutes, and more preferably not more than 10 minutes.

In the coagulation process, it is also preferred to raise the temperature rapidly by heating, and the temperature raising rate is preferably not less than 1° C./min. The upper limit of the temperature raising rate is not specifically limited but is preferably not more than 15° C./min in terms of inhibiting formation of coarse particles due to rapid progress of fusion. Further, after a dispersion used for coagulation reaches a temperature higher than the glass transition temperature, it is critically important to maintain the temperature of the dispersion over a given period of time to continue fusion. Thereby, particle growth and fusion proceed effectively, resulting in enhanced durability of the finally obtained particles.

### Colorant:

There are usable colorants, such as carbon black, a magnetic material, a dye, a pigment and the like. Examples of carbon black include channel black, furnace black, acetylene black, thermal black and lamp black. Examples of a magnetic material include ferromagnetic metals of iron, cobalt or the like; alloys containing these metals; a ferromagnetic metal compound such as ferrite or magnetite; and an alloy which does not contain a magnetic metal but exhibits ferromagnetism upon being subjected to a heating treatment, such as an alloy, so-called Heusler's alloy, for example, manganese-copper-aluminum or manganese-copper-tin; and chromium dioxide.

Examples of dyes usable in the invention include C.I. Solvent Red 1, ibid 49, ibid 52, ibid 58, ibid 63, ibid 111, and ibid 112; C.I. Solvent Yellow 19, ibid 44, ibid 44, ibid 77, ibid 79, ibid 81, ibid 82, ibid 82, ibid 93, ibid 98, ibid 103, ibid 104, ibid 112 and ibid 12; C.I. Solvent Blue 15, ibid 36, ibid 60, ibid 70, ibid 93 and ibid 95. There may be used a mixture of these dyes. Examples of a pigment include C.I. Pigment red 5, ibid 48:1, ibid 53:1, ibid 57:1, ibid 122, ibid 139, ibid 144, ibid 149, ibid 166, ibid 177, ibid 178, and ibid 222; C.I. Pigment Orange 31 and ibid 43; C.I. Pigment Yellow 14, ibid 17, ibid 74, ibid 93, ibid 94, ibid 138, ibid 155, ibid 180, and ibid 185; C.I. Pigment Green 7; C.I. Pigment Blue 15:3, and ibid 60. There may be used a mixture of these. A number average primary particle size of a dye, which varies depending on the kind, is approximately from 10 to 200 nm.

### Dispersion of Colorant:

A colorant particle dispersion can be prepared by dispersing a colorant in an aqueous medium. It is preferred that a colorant is dispersed in an aqueous medium at a surfactant concentration higher than the critical micelle concentration. A colorant can be dispersed by using a dispersing machine known in the art. A surfactant may be any one known in the art.

### Wax:

There may be added a wax as a releasing agent. Examples of a wax include hydrocarbon waxes such as low molecular weight polyethylene wax, low molecular weight polypropylene wax, Fischer Tropsch wax, microcrystalline wax or paraffin wax; and ester waxes such as Carnauba wax, pentaerythritol behenic acid ester, behenyl behenate and behenyl citrate. These may be used singly or in combination thereof.

A wax is added preferably in a particle size of 70 to 500 nm and such a particulate wax is prepared, for example by dispersing it in an aqueous medium, as described later.

The content of a wax is preferably from 2 to 20% by mass, based on total mass of the resin particles, more preferably from 3 to 18% by mass, and still more preferably from 4 to 15% by mass.

The melting point of a wax is preferably from 50 to 95° C. in terms of low temperature fixability and releasability.

Onto the surfaces of the thus prepared micron-size particles can be formed an inorganic layer through a sol-gel method.

### EXAMPLES

The present invention will be further described with reference to examples. In the present invention, “part(s)” represents part(s) by mass, unless otherwise noted.

### Example 1

### Preparation of Resin Particles

Resin particles were prepared through an emulsion dispersion method, as follows. A mixture of 80 parts by mass of styrene, 20 parts by mass of 3-methacryloxypropyltriethoxysilane (KBE-503, produced by Shinetsu Silicone Co., Ltd.) and 20 parts by mass of azobiscyanovaleronitrile (V-60, produced by Wako Junyaku Co., Ltd.) was added to 560 parts by mass of an aqueous surfactant solution (containing 0.2% by mass sodium dodecylbenzenesulfonate) and subjected to high-speed shearing at a rate of 10,000 rpm by using CLEARMIX (CLM-150S, produced by M-Technique Co., Ltd.) to prepare a monomer dispersion. The thus prepare dispersion was placed into a polymerization device equipped with a stirrer, a condenser tube, a temperature sensor and a nitrogen introducing tube and reacted at 70° C. for 6 hours, while stirring under a nitrogen stream. Then, the reaction mixture was taken out and allowed to stand over a whole day and night with maintaining a temperature of 70° C. to complete polymerization, whereby a dispersion of parent particles was obtained.

### Formation of Inorganic Layer:

Into 1000 g of the dispersion of parent particles was added 10 g of aqueous ammonia (28% by mass) and stirred for 5 minutes. Subsequently, 30 g of tetraethoxysilane was dropwise added over 30 minutes and is further stirred over 5 hours at room temperature to form an inorganic material layer of silicon dioxide on the surface of an organic material layer. There was thus obtained a dispersion of organic-inorganic composite particles composed of an organic core and an inorganic shell.

### Hydrophobilization Treatment of Uppermost Surface:

To 1 kg of the dispersion of parent particles having formed an inorganic layer, as described above, were added 2.4 g of tetrapropylammonium bromide as a phase transfer catalyst and 45 g of hexamethyldisilazane as a hydrophobilizing agent, and stirred at 40° C. for 12 hours. Then, the foregoing mixture was dried by using a spray-drying apparatus to obtain organic-inorganic composite particles with hydrophobilized silicon dioxide surface and exhibiting a volume-based median diameter of 100 nm.

### Examples 2-6 and 9

Similarly to Example 1, hydrophobilized composite particles of Examples 2-6 and 9 were each prepared, provided that the kind of a phase transfer catalyst and the amount of a phase transfer catalyst, based on the hydrophobilizing agent, were varied as shown in Table 2.

### Example 7

There were prepared toner particles by wet-external addition of colloidal silica to toner particles according to the procedure described below.

### Preparation of Resin Particles:

Resin particles used for preparation of toner parent particles and having a multi-layered structure were prepared through first polymerization, second polymerization and third polymerization steps.

### (a) First Polymerization Step:

Into a reactor vessel fitted with a stirrer, a temperature sensor, a condenser tube and a nitrogen introducing device was fed 4 parts by mass of an ionic surfactant, polyoxyethylene (2) dodecyl ether sodium sulfate together with 3040 parts by mass of deionized water to prepare an aqueous surfactant solution. To the aqueous surfactant solution was added a polymerization initiator solution of 10 parts by mass of potassium persulfate (KPS) dissolved in 400 parts by mass of deionized water and the temperature was raised to 75° C., and then, a monomer mixture composed of compounds below was dropwise added into the reactor vessel over 1 hour.

| | |
|---|---|
| Styrene | 532 parts |
| n-Butyl acrylate | 200 parts |
| Methacrylic acid | 68 parts |
| n-Octylmercaptan | 16.4 parts |

After completing addition of the monomer, the reaction mixture was heated at 75° C. over 2 hours with stirring to perform polymerization (namely, the 1st polymerization) to prepare resin particles. The thus prepared resin particles were referred to resin particles A1. It was proved that the weight average molecular weight of the resin particle A1 prepared in the 1st polymerization was 16,500.

### (b) Second Polymerization Step:

A monomer mixture composed of compounds described below was fed into a flask equipped with a stirrer, and then, 93.8 parts by mass of paraffin wax (HNP-57, produced by Nippon Seiro Co., Ltd.) was added thereto and dissolved with heating to a temperature of 90° C. to prepare a monomer solution.

| | |
|---|---|
| Styrene | 101.1 parts |
| n-Butyl acrylate | 62.2 parts |
| Methacrylic acid | 12.3 parts |
| n-Octylmercaptan | 1.75 parts |

Meanwhile, an aqueous surfactant solution of 3 parts by mass of the above-described anionic surfactant dissolved in 1560 parts by mass of deionized water was prepared and heated to 98° C. To this aqueous surfactant solution was added 32.8 parts by mass (solid content) and further thereto, the foregoing monomer solution containing paraffin wax was added and dispersed in a mechanical disperser provided with a circulation path, CLEARMIX (produced by M-Technique Co., Ltd.) over 8 hours, whereby an emulsified particle dispersion having an average dispersed particle size of 340 nm was prepared.

Subsequently, a polymerization initiator solution of 6 parts by mass of potassium persulfate dissolved in 200 parts by mass of deionized water was added to the foregoing emulsified particle dispersion and heated at 98° C. over 12 hours to perform polymerization (namely, the 2nd polymerization), whereby resin particles were obtained. The thus obtained resin particles were referred to resin particles A2. It was proved that the weight average molecular weight of the resin particles A2 prepared in the 2nd polymerization step was 23,000.

### (c) 3rd Polymerization Step:

To the resin particles A2 prepared in the 2nd polymerization step was added a polymerization initiator solution of 5.45 parts by mass of potassium persulfate dissolved in 220 parts by mass of deionized water, and further thereto, a monomer mixture composed of compounds described below was dropwise added over 1 hour.

| | |
|---|---|
| Styrene | 293.8 parts |
| n-Butyl acrylate | 154.1 parts |
| n-Octylmercaptan | 7.08 parts |

After completing addition, the reaction mixture was stirred with heating over 2 hours to perform polymerization (namely, the 3rd polymerization). After completing polymerization, the reaction mixture was cooled to 28° C. to prepare resin particles used for preparation of toner parent particles. It was proved that the weight average molecular weight of the thus prepared resin particles was 26,800.

### Preparation of Colorant Particle Dispersion:

In 1600 parts by mass of deionized water was dissolved 90 parts by mass of sodium dodecylsulfate, while stirring. To this solution was added 420 parts by mass of carbon black (Mogul L, produced by Cabot Co.) and then stirred by using a stirrer (CLEARMIX, produced by M-Technique Co., Ltd.) to prepare a dispersion of colorant particles, which was referred to a colorant dispersion 1. It was proved that the average colorant particle size of the colorant dispersion 1 was 110 nm, which was determined in an electrophoresis light scattering photometer (ELS-800, produced by Otsuka Denshi Co., Ltd.).

### Preparation of Toner Parent Particles:

Toner parent particles were prepared in accordance with the procedure, as blow.

Into a reactor vessel fitted with a stirrer, a temperature sensor, a condenser tube and a nitrogen introducing device was fed the following composition and stirred.

| | |
|---|---|
| Resin particles used for | 420.7 parts (solids) |
| toner parent particles | |
| Deionized water | 900 parts |
| Colorant particle dispersion | 200 parts |

After controlling the temperature within the reactor vessel to 30° C., the pH was adjusted to 10 with an aqueous 5 mol/l sodium hydroxide solution.

Subsequently, an aqueous solution of 2 parts by mass of magnesium chloride hexahydrate dissolved in 1000 parts by mass of deionized water was added with stirring at 30° C. over 10 minutes. After allowed to stand for 3 minutes, temperature rise was started and the temperature of this mixture was raised to 65° C. over 60 minutes to perform coagulation of the foregoing particles. In this state, the particle sizes of coagulated particles were measured by using Multisizer 3 (produced by Beckman Coulter Co.). When the volume-based median diameter reached 6.5 μm, an aqueous solution of 40.2 g sodium chloride dissolved in 1000 parts by mass of deionized water was added thereto to terminate coagulation, whereby a toner assembly solution was prepared.

While stirring 1000 parts (solid content of 12% by mass) by mass of the thus prepared toner assembly solution, an aqueous sodium hydroxide solution was added to adjust the pH of the dispersion to 7. Subsequently, 200 parts by mass of a 25% by mass lauryltrimethylammonium chloride solution, KOTAMIN 24P (produced by KAO Co., Ltd.; composed of 25% by mass of lauryltrimethylammonium chloride, water of 50% by mass and 20% by mass of isopropyl alcohol) was added thereto and stirred for 30 minutes. Then, 3.3 parts by mass of colloidal silica (solid content of 40% by mass, SNOWTEX ZL, produced by NISSAN KAGAKU KOGYO Co., Ltd.) was dropwise added into the thus prepared toner parent particle dispersion over 2 hours. After completing addition, stirring was continued for 2 hours to form a particulate silicon dioxide layer on the toner parent particle surface, whereby a dispersion of toner parent particles formed of an organic core and an inorganic shell were prepared.

### Hydrophobilization of the Uppermost Surface:

To 1 kg of the foregoing dispersion were added 2.5 g of tetrabutylammonium bromide as a phase transfer catalyst and 48 g of hexamethyldisilazane as a hydrophobilizing agent and stirred at 40° C. over 3 hours. Thereafter, particles were separated through solid-liquid separation and dried under 40° C. hot air to obtain toner particles in which the surface of silica was hydrophobilized.

### Example 8

### Hydrophobilization of Colloidal Silica

To 1 kg of colloidal silica (solid content of 40% by mass, SNOWTEX ZL, produced by NISSAN KAGAKU KOGYO Co., Ltd.) was added 1.7 g of tetraethylammonium bromide as a phase transfer catalyst and 32 g of hexamethyldisilazane as a hydrophobilizing agent and stirred at 40° C. over 3 hours. Thereafter, the mixture was dried by spray drying to obtain hydrophobilized silicon dioxide particles.

### Comparison Example 1

Hydrophobilized composite particles were prepared in the same manner as in Example 1, except that no phase transfer catalyst was used.

### Evaluation:

Evaluation was made by determining a degree of hydrophobilization. The degree of hydrophobilization was determined by measuring methanol wettability, as described earlier.

### Evaluation was Made Based on the Following Criteria:

A: A methanol wettability being not less than 45%,

B: A methanol wettability being less than 45% and not less than 40%,

C: A methanol wettability being less than 40%.

A methanol wettability of not less than 40% was acceptable in practice.

The results are shown in Table 1.

TABLE 1

| | | | Particle | | | | Degree of | |
|---|---|---|---|---|---|---|---|---|
| | | Particle | Solid | | | | Hydro- | |
| Example | | Size | Content | | | | phobicity | Eval- |
| No. | Particle Form | (nm) | (mass %) | *1 | Phase Transfer Catalyst | *2 | (%) | uation |
| 1 | Organic-inorganic composite particle | 100 | 15 | 5 | Tetrapropylammonium bromide | 5 | 66% | A |
| 2 | Organic-inorganic composite particle | 100 | 15 | 5 | Tetrapropylammonium bromide | 0.1 | 46% | A |
| 3 | Organic-inorganic composite particle | 100 | 15 | 5 | Tetrapropylammonium bromide | 0.05 | 42% | B |
| 4 | Organic-inorganic composite particle | 100 | 15 | 5 | Tetrapropylammonium bromide | 20 | 60% | A |
| 5 | Organic-inorganic composite particle | 100 | 15 | 5 | Tetrabutylammonium bromide | 5 | 64% | A |
| 6 | Organic-inorganic composite particle | 100 | 15 | 5 | Tetrabutylammonium bromide | 5 | 61% | A |
| 7 | Organic-inorganic composite particle | 6.5 μm | 12 | 5 | Tetrabutylammonium bromide | 5 | 64% | A |
| 8 | Colloidal silica | 100 | 40 | 5 | Tetrabutylammonium bromide | 5 | 58% | A |
| 9 | Organic-inorganic composite particle | 100 | 15 | 5 | Tetrapropylphosphonium | 5 | 61% | A |
| | | | | | bromde | | | |
| Comp. 1 | Organic-inorganic composite particle | 100 | 15 | 5 | — | — | 13% | C |

*1: Concentration (mass %) of hydrophobilizing agent, based on water
*2: Concentration (mass %) of phase transfer catalyst, based on hydrophobilizing agent

As is apparent from the results of Table 1, it was proved that particles of enhanced hydrophobicity were readily obtained by employment of the hydrophobilization technique of the invention.

What is claimed is:

1. A hydrophobilization method comprising:
subjecting particles to a hydrophobilizing treatment in an aqueous medium with a hydrophobilizing agent to hydrophobilize surfaces of the particles,
wherein the surfaces of the particles are hydrophobilized with the hydrophobilizing agent in the presence of a phase transfer catalyst.

2. The method of claim 1, wherein the phase transfer catalyst is a compound represented by the following formula (1): 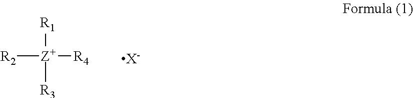
wherein R₁, R₂, R₃ and R₄, are independently an aryl group, an alkyl group having 1 to 12 carbon atoms, or an aralkyl group; Z is a nitrogen atom or a phosphorus atom; and X is a fluorine atom, a chlorine atom, a bromine atom, an iodine atom or phosphorus hexafluoride.

3. The method of claim 1, wherein the phase transfer catalyst is contained in an amount of not less than 0.1% by mass and not more than 20% by mass, based on the hydrophobilizing agent.

4. The method of claim 2, wherein the phase transfer catalyst is a tetraalkylammonium compound or a tetraalkylphosphonium compound.

5. The method of claim 1, whereon the hydrophobilizing agent is at least a compound selected from the group consisting of a silazane, a siloxane and a silane.

6. The method of claim 1, wherein the particles are metal oxide particles.

7. The method of claim 6, wherein the metal oxide particles are silicon dioxide particles.

8. The method of claim 1, wherein the particles are organic-inorganic composite particles which comprise organic particles covered with a metal oxide.

9. The method of claim 8, wherein the metal oxide is silicon dioxide.

10. The method of claim 8, wherein the organic particle each comprise a resin and a colorant.

11. The method of claim 1, wherein the surfaces of the particles are surfaces of micron-sized toner particles.

12. The method of claim 1, wherein the surfaces of the particles are surfaces of toner parent particles with attached inorganic particles.
